(19) United States
(12) Patent Application Publication
(10) Pub. No.: US 2017/0374276 A1
(43) Pub. Date: Dec. 28, 2017

(54) CONTROLLING CAPTURING OF A MULTIMEDIA STREAM WITH USER PHYSICAL RESPONSES

(71) Applicant: Intel Corporation, Santa Clara, CA (US)

(72) Inventors: KARTHIK VEERAMANI, Hillsboro, OR (US); RAJNEESH CHOWDHURY, Portland, OR (US)

(21) Appl. No.: 15/191,058

(22) Filed: Jun. 23, 2016

(51) Int. Cl. H04N 5/232; G02B 27/01; G06F 3/01; H04N 7/18

(52) U.S. Cl. CPC H04N 5/23219; H04N 7/185; H04N 5/23296; G02B 27/017; G06F 3/012; G06F 3/013; G02B 2027/0178

(57) ABSTRACT

Apparatuses, methods, and storage media associated with generating control instructions to control a camera or a robot having the camera in continuously capturing and providing of a multimedia stream are disclosed herein. An apparatus comprises sensors to collect data on a user's physical response to the multimedia stream. Intermediate or derived data that describe the user's physical response, and one or more control instructions to control the camera or the robot are generated based on the collected data on the user's physical response, by a wearable device, a proximally disposed mobile device, or the robot itself. Another apparatus comprises a camera to capture and provide the multimedia stream, and a control module to process or generate instructions to control the camera or the robot. The apparatuses further comprise transmitters and receivers to transmit and/or receive the multimedia stream, the collected data, the intermediate or derived data, or the control instructions.

### TECHNICAL FIELD

The present disclosure relates to the fields of digital media. In particular, the present disclosure relates to controlling the capturing of a multimedia stream, e.g., by a camera on a robot such as a drone, with user physical responses.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A robot is a machine designed to execute one or more tasks repeatedly, with speed and precision. There may be as many different types of robots as there are tasks for them to perform. A robot can be controlled by a user from various distances. Often wireless communication may be used to facilitate control of the robot.

A drone is an unmanned aircraft, which may be considered a flying robot. Drones may be more formally known as unmanned aerial vehicles (UAV). A drone may be remotely controlled or can fly autonomously through software-controlled flight plans in their embedded systems. UAVs have most often been associated with the military but they may also be used for search and rescue, surveillance, traffic monitoring, weather monitoring, and firefighting, among other things. A drone with integrated sensors, cameras, computing, and communication technologies, can be used by any industry in ways that can transform, improve, and even save lives.

Often a drone may be controlled by mobile devices on the ground providing touch or mouse inputs to maneuver the drone. However, there may be situations when the touch or mouse inputs may not be feasible or desirable. For example, an army personnel or a special force soldier may be walking and holding a weapon, while a drone flying ahead surveys the path for danger. As another example, mountain climbers may be climbing with their hands and legs, while using a drone flying ahead to survey the path. In any of these examples, since the hands of the users are not free, it may not be feasible to control the drone flying ahead using touch or mouse inputs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example operational flow between a drone and a wearable device in controlling capturing of a multimedia stream by a camera on the drone with user physical responses, together with some components of the drone, an example wearable device, and an optional proximally disposed mobile device, in accordance with various embodiments.

FIG. 2 illustrates an example component view of a drone, a wearable device, and a mobile device, in accordance with various embodiments.

FIG. 3 illustrates an example process for controlling capturing of the multimedia steam by a camera on a robot such as a drone with user physical responses, in accordance with various embodiments.

FIG. 4 illustrates another example process for controlling capturing of a multimedia stream by a camera on a robot such as a drone with user physical responses, in accordance with various embodiments.

FIG. 5 illustrates another example process for controlling capturing of a multimedia stream by a camera on a robot such as a drone with user physical responses, in accordance with various embodiments.

FIG. 6 illustrates an example implementation of a drone, a wearable device, and/or a mobile device, in accordance with various embodiments.

### DETAILED DESCRIPTION

Apparatuses, methods and storage medium are disclosed herewith related to controlling capturing of a multimedia stream by e.g., a camera on a robot such as a drone, with user physical responses. Often a robot, such as a drone, can be controlled by mobile devices on the ground providing touch or mouse inputs to maneuver the robot. At home environments, it has become common to pair a drone with tablets or smartphones, providing touch controls to fly the drone. However, depending on the scenario that the robot is deployed, the touch or mouse control can be quite cumbersome, and may not be feasible or desirable. Embodiments disclosed herein may allow controlling capturing of a multimedia stream by e.g., a camera on a robot such as a drone, with user physical responses, and hands free operations in a manner natural to the user, hence providing a much better user experience.

Embodiments herein can take advantages of the fact that a user's physical responses, such as eye movements or head movements, related to a multimedia steam captured by a camera on a drone may indicate the user's intention for controlling the camera or the drone to obtain further updated multimedia views from the camera. For example, head mounted devices such as smart glasses, may include receivers and a display for receiving and displaying a multimedia stream sent from the camera. The head mounted devices may further include sensors, such as infrared (IR) cameras etc., configured to track the user's eyes, and provide the eye's angle changes to generate instructions to control the camera or the drone. On receipt of the eye's angle changes, a controller in response, may cause the camera (or the drone) to pan at an angle responsive to the eye's angle changes. Similar operations could be performed to change the drone's direction or the camera's direction by tracking the user's head movements. The result may synchronize the drone's “vision” through the camera with that of the user's vision, allowing the user to see through the drone's “eyes”, e.g., a camera, using his own eyes or head movements.

Embodiments herein may include a receiver and a display device (which may be disposed on a wearable device) to receive and display to a user a multimedia stream captured and provided in real time by a camera on a robot. Embodiments herein may further include sensors to collect and provide data on the user's physical response to the multimedia stream, such as eye movements or head movements.

Embodiments herein may further include a control module (which may be disposed in a wearable device, a proximally disposed mobile device or the host robot of the camera) to generate intermediate or derived data that describe the user's physical response, and/or one or more control instructions to control a camera (or the host robot) in continuously capturing and providing of a multimedia stream. The control module may be configured to receive collected data on a user's physical response, such as head movements or eye movements, to the multimedia stream captured by the camera, or receive intermediate or derived data that describe the user's physical response, and generate the intermediate or derived data that describe the user's physical response, or the one or more control instructions to control the camera (or the host robot) based on the collected data or the intermediate or derived data.

Embodiments herein may further include a transmitter (which may be disposed on a wearable device or a proximally located mobile device) to send to the proximally disposed mobile device or the robot, the collected data, the intermediate or derived data, or the one or more control instructions to control the camera or the robot in continuously capturing and providing of the multimedia stream.

Embodiments herein may further include a camera (disposed on the host robot) to capture and provide a multimedia stream, and a transmitter (disposed on the host robot) to send the multimedia stream, as it is generated, to a wearable device.

Embodiments herein can be applied to many situations where a camera may be mounted on a robot or a drone. For example, if a solider on the battlefield may be surveying the scene ahead of his path using a drone while carrying a weapon, it may be hard for the solider to use the touch or mouse at his tablet to maneuver the drone's vision. Using embodiments herein, the solider may fly the drone up and down, and maneuver its vision and direction using his eyes and head by wearing a smart goggle. Embodiments herein can provide the solider with hand free control of the camera on the drone so that the solider can receive updated view captured by the camera based on the intention of the solider as demonstrated by the soldier's physical response to the captured view by the camera. Using the embodiments herein, the solider can wear a smart goggle that displays the multimedia stream from the drone, allowing the solider to change the drone's vision/direction freely based on eye or head movements.

For ease of understanding, the remaining description will frequently refer to a drone. Those skilled in the art would appreciate that the drone may be for illustrations only and are not limiting, and the present disclosure may be applied to other robots with a camera. Further, the robots may be stationary, while the distance between the control and the camera on the robots may vary greatly from a short distance of a few inches or feet to thousands of miles away, depending on the capability of the companion communication arrangements.

In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

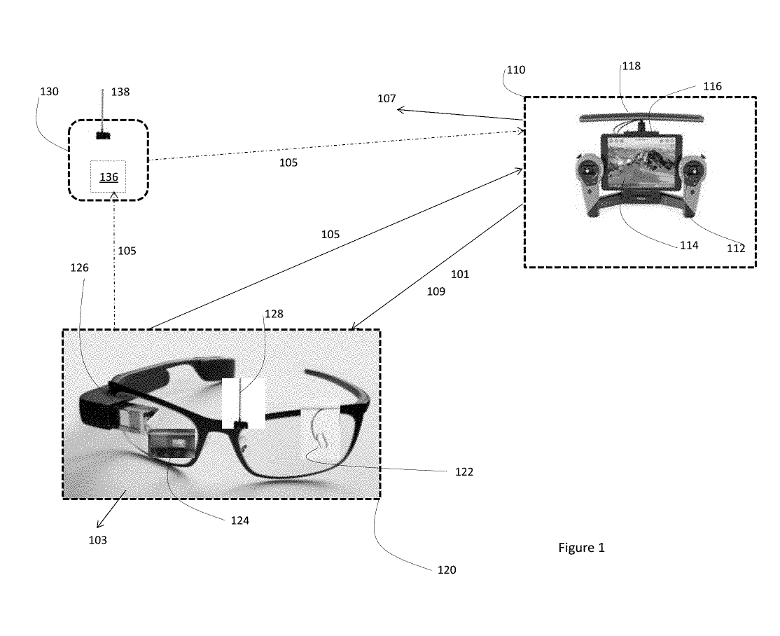

Referring now to FIG. 1, wherein example operational flows between drone 110, wearable device 120, and optional proximally disposed mobile device 130, according to various embodiments, are shown. Embodiments of the operational flow may control capturing of a multimedia stream by camera 112 on drone 110 with user physical responses collected by wearable device 120. In addition, some components of drone 110, wearable device 120, and mobile device 130 may be shown, in accordance with various embodiments. In further details, drone 110 may include camera 112, display 114, control module 116, and transceiver (TR) 118. In addition, wearable device 120 may include sensor 122, display 124, control module 126, and TR 128, in accordance with various embodiments. Furthermore, mobile device 130 may be optionally and proximally disposed to wearable device 120, comprising control module 136, and TR 138.

Even though it is shown that sensor 122, display 124, control module 126, and TR 128 are placed on wearable device 120, one or more of these components, e.g., control module 126, may be physically separated and proximally located with wearable device 120. In alternate embodiments, one or more of TR 118, 128, and 138 may be implemented using separate transmitter and receiver.

Drone 110 may be configured to communicate with wearable device 120 through communication channels, where a “forward channel” may be the path from drone 110 to wearable device 120, and a “back channel” may be the path from wearable device 120 (or mobile device 130) to drone 110. The forward channel and the back channel may be wireless communication channels.

In embodiments, operations between drone 110 and wearable device 120 may follow an example operational flow described below. Wearable device 120 may be a wearable eyeglass as shown in FIG. 1. However, wearable device 120 may include other kinds of devices attached to a user, or worn by the user, not shown in the figure.

In embodiments, as shown in operation 101, drone 110 may start capturing a scene continuously through its camera 112, encoding the frames and streaming the successive frames as a multimedia stream to wearable device 120, which may display the received multimedia stream on the display 124. The multimedia stream could be formed from a single camera, or carries stereoscopic video from multiple cameras fitted on drone 110, to mimic human eyesight.

In embodiments, as shown in operation 103, transceiver 128 may receive a multimedia stream captured and provided in real time by camera 112 on drone 110. The user of wearable device 120 may see the multimedia stream displayed on display 124. Sensor 122 may be configured to collect and provide the data on the user's physical response to the multimedia stream.

In embodiments, based on the collected user's physical response data, control module 126 may determine the user's physical responses, e.g., the user's eyes or head movements, and based on the user's physical responses, generate one or more control instructions to drone 110 to control continuous capturing and providing of the multimedia stream by the camera. The control instructions may be directed to camera 112 or drone 110, as described in more detail below.

In embodiments, instead of generating the one or more control instructions to drone 110 to control the drone or the camera, control module 126 may generate intermediate or derived data that describe the user's physical response, which may be further used to generate by another component, such as control module 136 on mobile device 130, or control module 116 on drone 110, the one or more control instructions to drone 110 to control the drone or the camera.

In embodiment, control module 126 may be moved from wearable device 120 onto proximally disposed mobile device 130, so that there is no control module on wearable device 120. Accordingly, wearable 120 may receive the multimedia stream, collect and provide collected or derived data on a user's physical response to the multimedia stream, without generating the ultimate control instructions.

In embodiments, the collected user's physical response data may be in a form of raw data of locations of user's eyes or head at coordinates (x, y, z). On the other hand, the intermediate or derived data may describe the user's physical response such as the angle of movements of the user's eyes or head rightwards or leftwards. Such intermediate or derived data may be generated from multiple collected data of the user's physical response. For example, control module 126 may generate an intermediate data describing the user's eyes moving rightwards at 45 degree, when the initial position of the eyes, and the ending position of the eyes show such an eye movement. In addition, the one or more control instructions to drone 110 to control the drone or the camera may be of the form “action object direction degree”. For example, “move camera rightwards 45” may be an instruction to control the camera to move rightwards by 45 degrees. As an alternative, the instruction “move camera rightwards 45” may be simplified as “move+45,” where the object camera is omitted, and the direction “rightwards” is represented by a positive sign. There may be many possible formats for the one or more control instructions to drone 110 to control the drone or the camera.

In embodiments, as shown in operation 105, transceiver 128 at wearable device 120 may be configured to transmit the collected data, the intermediate or derived data, or the one or more control instructions, to proximally disposed mobile device 130 or the robot 110 to control continuous capturing and providing of the multimedia stream by the camera. The collected data, the intermediate or derived data, or the one or more control instructions may be transmitted to drone 110 through the back channel of a wireless communication channel.

In embodiment, transceiver 128 at wearable device 120 may be configured to transmit the collected data, or the intermediate or derived data, to proximally disposed mobile device 130 for further processing to generate the intermediate or derived data, or the one or more control instructions to control camera 120 or robot 110. For example, transceiver 128 may transmit the collected data to mobile device 130, where mobile device 130 may generate the intermediate or derived data, or the one or more control instructions. Alternatively, transceiver 128 may transmit the intermediate or derived data to mobile device 130, where mobile device 130 may generate the one or more control instructions.

In embodiments, as shown in operation 107, drone 110 may be configured to receive from either wearable device 120 or mobile device 130, collected data on a user's physical response to the multimedia stream, intermediate or derived data that describe the user's physical response to the multimedia stream, or one or more control instructions. In embodiments where collected data or intermediate or derived data are received, control module 116 may generate the one or more control instructions from received collected data or intermediate or derived data.

In embodiments, when the one or more control instructions are received via operation 105 or generated via operation 107 from received data, the one or more control instructions may control camera 112 directly, or indirectly via control of the movement of drone 110, based on the one or more control instructions. For example, drone 110 may control orientation and/or focus of the camera through control module 116. In some other embodiments, control module 116 may control e.g., movement and/or orientation of drone 110, which in turn indirectly “controls” the orientation of camera 116. In other words, the interaction between control module 116 and camera 112 may be a direct interaction, or an indirect interaction. In the description below, “control” can be either a direct control or an indirect control, even though it may not be explicitly stated so.

In embodiments, control module 116 may pan the camera, directly or indirectly, according to the received instructions, making the camera focus on the part of the scene the user wishes to see as determined by from collected data based on the user's physical response. For example, the camera/drone may be held steady when one or more control instructions instruct to keep the camera steady (in response to the user keeping his/her eyes/head steady). As another example, the camera may be moved rightward when one or more control instructions instruct to move the camera/drone rightward (in response to the user moving his/her eyes/head rightward), or moved leftward when one or more control instructions instruct to move the camera/drone leftward (in response to the user moving his/her eyes/head leftward). As still a further example, the camera may zoom out when one or more control instructions instruct to zoom out (in response to the user panning a displayed scene), or zoom in when one or more control instructions instruct to zoom in (in response to the focusing on a portion of a displayed scene).

Additionally and alternatively, in embodiments, control module 116 may cause the camera or the drone to be paused midair when the data on the user's eye movement indicates the user's eyes blink twice quickly, or cause the camera to take a snapshot and keep the snapshot in a storage local to the camera or the robot when the data on the user's eye movement indicates the user's eyes blink three times quickly. In embodiments, control module 116 may decide how fast a speed for the eye blink would be interpreted as “quickly,” based on the situation the camera or the drone is applied to. The user may define such speed for interpreting “quickly” as well. Similarly, control module 116 may cause the camera or the drone to flip 180 degree when the data on the user's head movement indicates the user's head tilts at forty-five degrees. In addition, many other eye movements, or head movements, which may be naturally interpreted or defined specifically for certain task, can be translate into one or more control instructions to instruct the movements of the camera or the robot.

In embodiments, as shown in operation 109, the multimedia stream from camera 112 may be updated with the new scene generated post positioning of the camera/drone based on the one or more control instructions. The updated multimedia stream may be transmitted to wearable device 120. On receipt, the updated multimedia stream may be displayed on display 124 of wearable device 120. With the display of the updated multimedia stream on display 124, the user may have a better view of an area of interest, e.g., the user might see in sharper focus areas of the scene where the user has been looking at.

Before further describing the present disclosure, it should be noted that drone 110 may be other camera equipped robots, e.g., a bomb diffusion robot, a salvage robot, s submersible robot, and so forth.

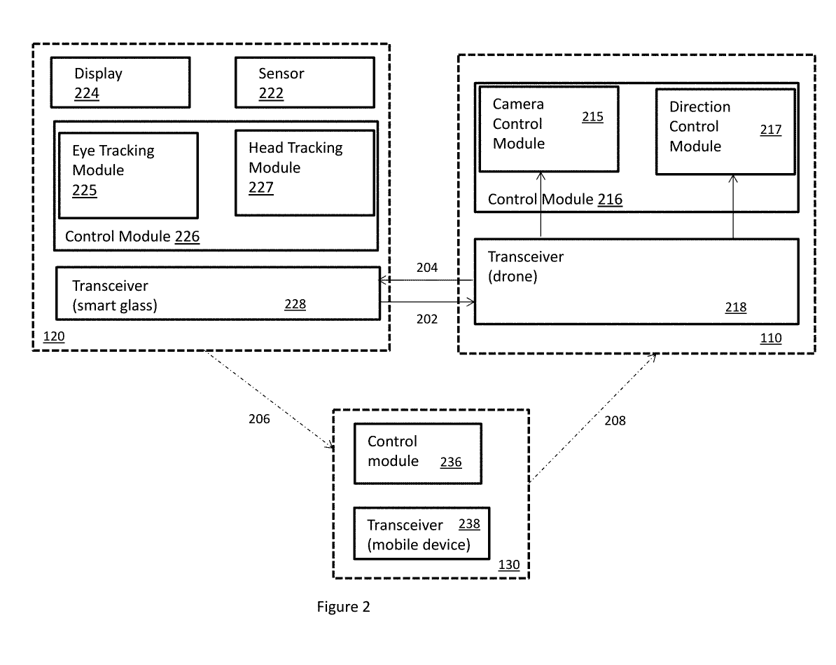

FIG. 2 illustrates an example component view of drone 110, wearable device 120, and mobile device 130, in accordance with various embodiments. As shown, for the illustrated embodiments, drone 110 may include control module 216 having camera control module 215 and direction control module 217, and transceiver 218. Wearable device 120 may include sensors 222, display 224, transceiver 228, and control module 226 having eye tracking module 225, and head tracking module 227. In addition, mobile device 130 may include control module 236 and transceiver 238.

In embodiments, drone 110 may send data through forward channel 204 to wearable device 120. Wearable device 120 may send data through back channel 202 to drone 110. In addition, wearable device 120 may send data to mobile device 130, which may further send data to drone 110, through channel 206. There may be other components of drone 110 and wearable device 120 not shown.

Transceiver 218 may be the same transceiver 118 of FIG. 1, while transceiver 228 may be the same transceiver 128 of FIG. 1. In addition, camera control module 215 and direction control module 217 may be a part of control module 116 of FIG. 1, performing functions of control module 116 as described herein. Similarly, sensors 222 may be sensors 122 of FIG. 1, performing functions of sensors 122 as described herein. Control module 226 having eye tracking module 225 and head tracking module 227 may be control module 126 of FIG. 1, performing functions of control module 126 as described herein. Eye tracking module 225 and head tracking module 227 may be respectively configured to determine the user's eye and head movements based on data collected by sensors mounted on wearable device 120.

For example, eye tracking module 225 may use many different methods to explore eye movement data, which may be collected by sensor 222. In embodiment, eye tracking module 225 may analyze a visual path of the user across an interface such as display 124 of FIG. 1. Each eye data observation may be translated into a set of pixel coordinates. From there, the presence or absence of eye data points in different screen areas can be examined. This type of analysis may be used to determine which features may be seen, when a particular feature captures attention, how quickly the eye moves, what content may be overlooked and virtually any other gaze-related question.

For example, if the user wishes to examine a specific part of the display, he may move the focus of his eyes towards that section. Eye tracking module 225 may capture the motions of eyes, and convert it to details of motion in a specific direction, such as intermediate or derived data that describe the user's physical response. In embodiments, when eye tacking module 225 determines that the user's eye movement indicates the user's eyes may be staring at an object of the multimedia stream, the main logic of control module 226 may generate the intermediate or derived data that describe the user's physical response, or one or more control instructions to attempt to keep the camera steady. When eye tacking module 225 on the user's eye movement indicates the user eyes move rightward related to the multimedia stream, the main logic of control module 226 may generate the intermediate or derived data that describe the user's physical response, or one or more control instructions to move the camera rightward. When eye tacking module 225 on the user's eye movement indicates the user eyes move to leftward related to the multimedia stream, the main logic of control module 226 may generate the intermediate or derived data that describe the user's physical response, or one or more control instructions to move the camera leftward.

Control based on eye tracking concept can be extended to head tracking. For example, when the user may wish to see what may be on the left or right sides of the drone's vision, he could turn his head in that direction. Head tracking module 227 attached to wearable device 120 may determine the motions of head, and convert it to details of motion in a specific direction. In embodiments, when head tacking module 227 determines the user's head movement indicates the user head may be stationary with respect to the multimedia stream, the main logic of control module 226 may generate the intermediate or derived data that describe the user's head being stationary, or one or more control instructions to attempt to keep the camera steady. When head tacking module 227 determines the user's head movement indicates the user's head moves rightward related to the multimedia stream, the main logic of control module 226 may generate the intermediate or derived data that describe the user's head moving rightward, or one or more control instructions to move the camera rightward. When head tacking module 227 determines the user's head movement indicates the user's head moves to leftward related to the multimedia stream, the main logic of control module 226 may generate the intermediate or derived data that describe the user's head moving leftward, or one or more control instructions to move the camera leftward.

In some embodiments, transceiver 238 in mobile device 130 may receive data from wearable device 120 through channel 206, wherein the received data may be collected data on a user's physical response to a multimedia stream captured and provided in real time by a camera disposed on drone 110, or the intermediate or derived data that describe the user's physical response to the multimedia stream. When transceiver 238 receives the collected data, control module 236 may generate intermediate or derived data that describe the user's physical response, which may be further used to generate by another component, such as control module 216 on drone 110. Alternatively, control module 236 may generate the one or more control instructions to control the camera or drone 110. When transceiver 238 receives the intermediate or derived data, control module 236 may generate the one or more control instructions to control the camera or drone 110. The intermediate or derived data, or the ultimate control instructions may be provided to drone 110 via channel 208.

The earlier described back channel 202/208, forward channel 204, and channel 206 of a wireless communication channel, may follow any one of a number of wireless protocols. In some embodiments, drone 110, wearable device 120, and mobile device 130 may communicate using the Miracast standard. Miracast is a standard for peer-to-peer, Wi-Fi direct wireless connections from devices (such as laptops, tablets, or smartphones) to displays. Device communicating in Miracast can send up to 1080p HD video (H.264 codec). Technology such as the Miracast can enable a drone from one vendor interoperates with a wearable device from another vendor. Drone 110 may include a Miracast capable transceiver and similarly wearable device 120 (and/or the proximally located mobile device 130) may likewise include a Miracast transceiver. In embodiments, some other wireless communication technology may be used to communicate between drone 110, wearable device 120, and mobile device 130.

While setting up the connection for back channel 202/208, forward channel 204, and channel 206, drone 110, wearable device 120, and mobile device 130 may negotiate the capability of sending/accepting information. If using Miracast, the User Input Back Channel (UIBC) protocol may allow establishing such communication paths.

However, existing Miracast protocol may not be efficient in transmitting one or more the collected data on a user's physical response to a multimedia stream, the intermediate or derived data, or the one or more control instructions to control continuous capturing and providing of the multimedia stream by a camera. For example, currently Miracast supports input methods such as touch, keyboard, mouse, but not instructions generated based on user physical responses such as eye or head movements.

In embodiments, the collected data, the intermediate or derived data, or the one or more control instructions based on user physical responses such as eye or head movements may be transmitted in special designed and reserved spaces within communication packets of a wireless communication protocol. In embodiments, the collected data, the intermediate or derived data, or the one or more control instructions based on user physical responses such as eye or head movements may be transmitted with an indication of a source of the user's physical response. For example, the collected data, the intermediate or derived data, or the one or more control instructions may be carried in the wireless communication protocol by 4 octets with an indication of whether the collected data, the intermediate or derived data, or the one or more control instructions are obtained from eye tracking or head tracking.

In embodiments, the UIBC protocol in Miracast specification may be extended to include the eye and head tracking data, which may be the collected data or the intermediate or derived data as shown in Table 1 below.

TABLE 1

| Generic input type ID | |
|---|---|
| 9 | Eye tracking |
| 10 | Head tracking |

In embodiments, the UIBC protocol may be extended to include the eye and head tracking data, describing fields of the generic input message for eye tracking and head tracking, where the message may be the collected data or the intermediate or derived data, based on user physical responses such as eye or head movements, as shown in Table 2 below.

TABLE 2

| | Size | |
|---|---|---|
| Field | (Octet) | Notes |
| Angle | 4 | Angle of movement of the eyes in radians. Zero radian may |
| | | indicate a direct vision. A negative number may indicate eyes |
| | | looking on the left side, and a positive number on the right |
| | | side. The type may be a floating point number adhering to |
| | | IEEE 754. |
| | 4 | Angle of movement of the head in radians. Zero radian may |
| | | indicate a position of the head when it may be looking directly |
| | | ahead. A negative number may indicate head looking on the |
| | | left side, and positive number on the right side. The type may |
| | | be a floating point number adhering to IEEE 754. |

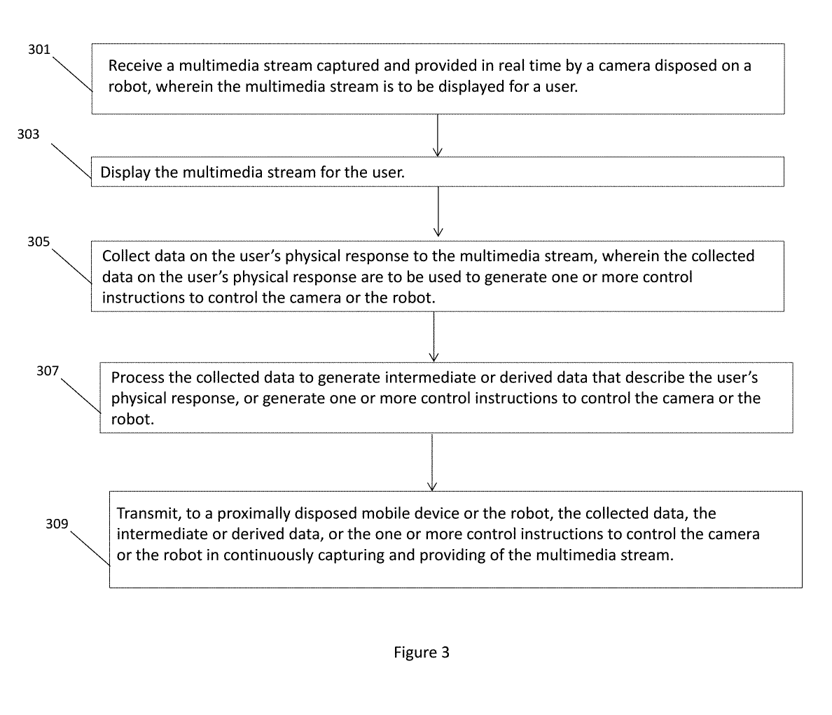

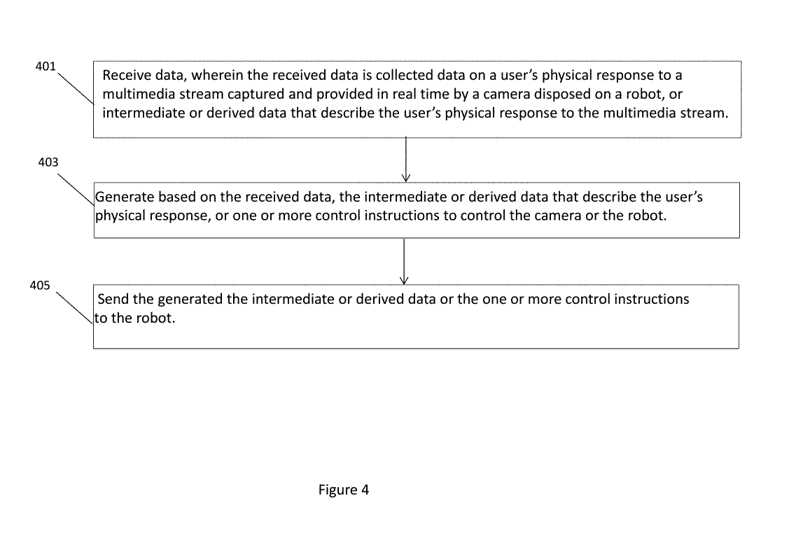

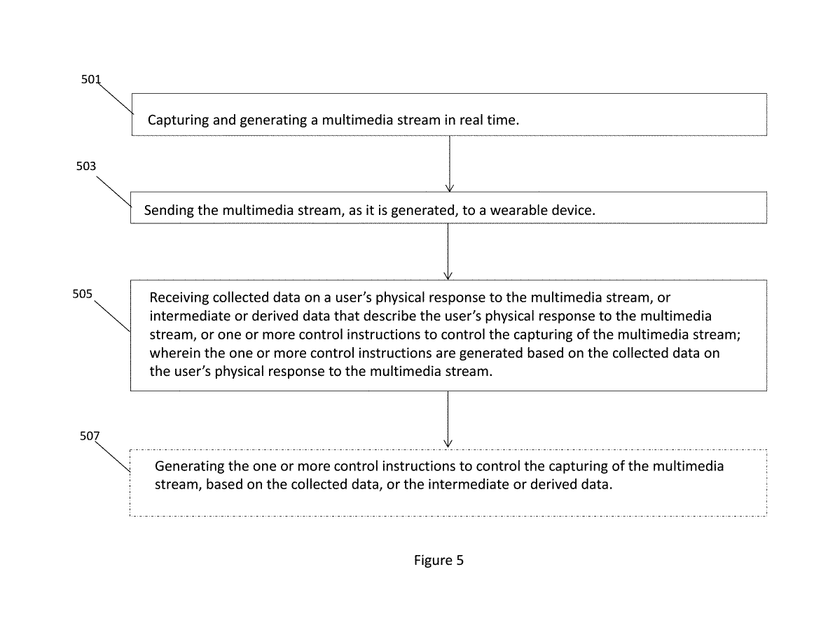

In summary, FIG. 1 and FIG. 2 presented descriptions on how drone 110, wearable device 120, and optionally, mobile device 130 may interact with each other in controlling capturing of a multimedia stream by a camera on the drone with user physical responses. FIGS. 3-5 below describes how each device may perform its own process, including a process for wearable device 120 as shown in FIG. 3, a process for mobile device 130 as shown in FIG. 4, and a process for drone 110 as shown in FIG. 5. Accordingly, each of these Figures also depicts the algorithmic structure of the modules involved.

FIG. 3 illustrates an example process for controlling capturing of the multimedia steam by the camera with user physical responses, in accordance with various embodiments. The example process may be performed by wearable device 120 as shown in FIG. 1 and FIG. 2. In embodiments, a computer device, e.g., wearable device 120 of FIG. 1 and FIG. 2, may receive (e.g., by TR 128/228) a multimedia stream captured and provided in real time by a camera (e.g., camera 112), disposed on a robot (e.g., drone 110), wherein the multimedia stream is to be displayed for a user (301); and display (e.g., on display 124) the multimedia stream for the user (303). Additionally, the computer device may collect data on the user's physical response to the multimedia stream by sensors (e.g., sensors 122), wherein the collected data on the user's physical response are to be used to generate one or more control instructions to control the camera or the robot (305). Further, the computer device may process the collected data to generate intermediate or derived data that describe the user's physical response, and/or generate one or more control instructions to control the camera or the robot (307) (e.g., by control module 126/226). In some embodiments, the collected data or the intermediate or derived data may be transmitted (309) to a proximally disposed mobile device (e.g. mobile device 130) or the robot (e.g., drone 110). In other embodiments, the one or more control instructions may be transmitted to control the camera or the robot in continuously capturing and providing of the multimedia stream (309).

FIG. 4 illustrates another example process for controlling capturing of a multimedia stream by a camera (e.g., camera 112) on a robot (e.g., drone 110) with user physical responses, in accordance with various embodiments. The example process may be performed by mobile device 130 as shown in FIG. 1 and FIG. 2. In embodiments, the process may comprise: receive data, wherein the received data may be collected data on a user's physical response to a multimedia stream captured and provided in real time by a camera (e.g., camera 112) disposed on a robot (e.g., drone 110), or intermediate or derived data that describe the user's physical response to the multimedia stream (401). The process may further comprises: generate based on the received data, the intermediate or derived data that describe the user's physical response, or one or more control instructions to control the camera or the robot (403); and send the generated the intermediate or derived data or the one or more control instructions to the robot (e.g., drone 110) (405).

FIG. 5 illustrates another example process for controlling capturing of a multimedia stream by a camera (e.g., camera 112) on a robot (e.g., drone 110) with user physical responses, in accordance with various embodiments. The example process may be performed by drone 110 as shown in FIG. 1 and FIG. 2. In embodiments, the process may comprise: capturing and generating a multimedia stream in real time (501) by the camera (e.g., camera 112) on a robot (e.g., drone 110); and sending the multimedia stream, as it is generated, to a wearable device (e.g., wearable device 120) (503). Additionally, the process may further comprises: receiving collected data on a user's physical response to the multimedia stream, or intermediate or derived data that describe the user's physical response to the multimedia stream, or one or more control instructions to control the capturing of the multimedia stream; wherein the one or more control instructions are generated based on the collected data on the user's physical response to the multimedia stream (505). Further, for embodiments, where collected data or intermediate or derived data are received, the process may comprise: the optional operation of generating the one or more control instructions to control the capturing of the multimedia stream, based on the collected data, or the intermediate or derived data (507). Next, the camera and/or the drone may be controlled in accordance with the control instructions (509).

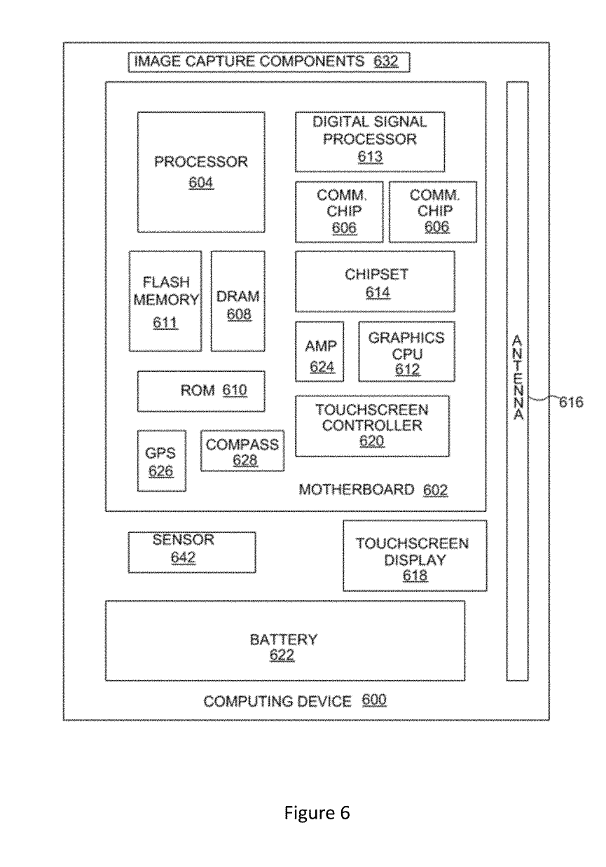

FIG. 6 illustrates an example implementation of a drone such as drone 110, a wearable device such as wearable device 120, and/or a mobile device such as mobile device 130, in accordance with various embodiments. Depending on the actual components included, computing device 600 may be suitable for use as wearable device 120, mobile device 130, or drone 110 of FIG. 1 or 2. In embodiments, computer device 600 may house a motherboard 602. The motherboard 602 may include a number of components, including but not limited to a processor 604 and at least one communication chip 606. The processor 604 may be physically and electrically coupled to motherboard 602. In some implementations the at least one communication chip 606 may also be physically and electrically coupled to motherboard 602. In further implementations, the communication chip 606 may be part of the processor 604. In alternate embodiments, the above enumerated may be coupled together in alternate manners without employment of motherboard 602.

Depending on its applications, computer device 600 may include other components that may or may not be physically and electrically coupled to motherboard 602. These other components may include, but are not limited to, volatile memory (e.g., DRAM 608), non-volatile memory (e.g., ROM 610), flash memory 611, a graphics processor 612, a digital signal processor 613, a crypto processor (not shown), a chipset 614, an antenna 616, a display (not shown), a touchscreen display 618 (for mobile device 130), a touchscreen controller 620 (for mobile device 130), a battery 622, an audio codec (not shown), a video codec (not shown), a power amplifier 624, a global positioning system (GPS) device 626, a compass 628, one or more sensors 642 (in particular for wearable device 110, sensors for sensing eye/head movements of a user), an accelerometer, a gyroscope, a speaker, user and away facing optical or electromagnetic image capture components 632, and a mass storage device (such as hard disk drive, compact disk (CD), digital versatile disk (DVD), and so forth).

In various embodiments, volatile memory (e.g., DRAM 608), non-volatile memory (e.g., ROM 610), and/or flash memory 611, may include instructions to be executed by processor 604, graphics processor 612, digital signal processor 613, and/or crypto processor, to practice various aspects of the methods and apparatuses described earlier with references to FIGS. 1-5 on wearable device 120, mobile device 130, or drone 110.

The communication chip 606 may enable wired and/or wireless communications for the transfer of data to and from the computing device 600 through one or more networks. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others.

The processor 604 of the computing device 600 may include an integrated circuit die packaged within the processor 604. The term “processor” may refer to any device or portion of a device (e.g., a processor core) that processes electronic data from registers and/or memory to transform that electronic data into other electronic data that may be stored in registers and/or memory.

The communication chip 606 may also include an integrated circuit die packaged within the communication chip 606.

In further implementations, another component housed within the computing device 600 may contain an integrated circuit die that may include one or more devices, such as processor cores, cache and one or more memory controllers.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Example 1 may include an apparatus comprising: a receiver to receive a multimedia stream captured and provided in real time by a camera disposed on a robot, wherein the multimedia stream is to be displayed for a user; and sensors to collect data on the user's physical response to the multimedia stream, wherein the collected data on the user's physical response are to be used to generate one or more control instructions to control the camera or the robot.

Example 2 may include the apparatus of example 1 and/or some other examples herein, further comprising a display device coupled to the receiver to display the multimedia stream for the user.

Example 3 may include the apparatus of example 1 and/or some other examples herein, further comprising a transmitter coupled to the sensors to transmit the collected data to a proximally disposed mobile device to process the collected data to generate the one or more control instructions to control the camera or the robot.

Example 4 may include the apparatus of example 3 and/or some other examples herein, wherein the mobile device comprises a smartphone or a portable drone controller.

Example 5 may include the apparatus of example 1 and/or some other examples herein, further comprising a transmitter coupled to the sensors to transmit the collected data to the robot to process the collected data to generate the one or more control instructions to control the camera or the robot.

Example 6 may include the apparatus of example 1 and/or some other examples herein, further comprising: a processor with one or more processor cores; a control module coupled with the sensors and the processor to process the collected data to generate intermediate or derived data that describe the user's physical response; and a transmitter coupled to the control module to transmit the generated intermediate or derived data to either a proximally disposed mobile device or the robot to generate the one or more control instructions to control the camera or the robot.

Example 7 may include the apparatus of example 6 and/or some other examples herein, wherein the generated intermediate or derived data are transmitted with an indication of a source of the user's physical response.

Example 8 may include the apparatus of example 6 and/or some other examples herein, wherein the generated intermediate or derived data are transmitted in reserved spaces within communication packets of a wireless communication protocol.

Example 9 may include the apparatus of example 1 and/or some other examples herein, further comprising a processor with one or more processor cores; a control module coupled with the sensors and the processor to process the collected data to generate the one or more control instructions to control the camera or the robot; and a transmitter coupled with the control module to transmit the one or more control instructions to the robot.

Example 10 may include the apparatus of example 9 and/or some other examples herein, wherein the robot is a drone, the receiver is to receive the multimedia stream from the drone through a wireless communication channel, and the transmitter is to transmit the one or more control instructions to the drone through the wireless communication channel.

Example 11 may include the apparatus of example 9 and/or some other examples herein, wherein the apparatus is a wearable device comprising the receiver, the sensors, the transmitter, and the control module.

Example 12 may include the apparatus of example 9 and/or some other examples herein, wherein the control module is to cause the transmitter to transmit the one or more control instructions in reserved spaces within communication packets of a wireless communication protocol.

Example 13 may include the apparatus of example 9 and/or some other examples herein, wherein the one or more control instructions are transmitted with an indication of a source of the user's physical response.

Example 14 may include the apparatus of examples 1-13 and/or some other examples herein, wherein the sensors are to track and collect data on the user's eye movement relative to the multimedia stream, and the one or more control instructions are generated based at least in part on the collected data on the user's eye movement.

Example 15 may include the apparatus of examples 14 and/or some other examples herein, wherein one of the one or more generated control instructions is to attempt to keep the camera or the robot steady when the data on the user's eye movement indicates the user's eyes are staring at an object of the multimedia stream, one of the one or more generated control instructions is to move the camera or the robot rightward when the data on the user's eye movement indicates the user eyes move rightward related to the multimedia stream, and one of the one or more generated control instructions is to move the camera or the robot leftward when the data on the user's eye movement indicates the user eyes move to leftward related to the multimedia stream.

Example 16 may include the apparatus of example 14 and/or some other examples herein, wherein one of the one or more generated control instructions is to instruct the camera to zoom out when the data on the user's eye movement indicates the user's eyes are panning a displayed scene, one of the one or more generated control instructions is to instruct the camera to zoom in when the data on the user's eye movement indicates the user's eyes are focusing on a portion of a displayed scene, one of the one or more generated control instructions is to instruct the camera to pause midair when the data on the user's eye movement indicates the user's eyes blink twice quickly, and one of the one or more generated control instructions is to instruct the camera to take a snapshot and keep the snapshot in a storage local to the camera or the robot when the data on the user's eye movement indicates the user's eyes blink three times quickly.

Example 17 may include the apparatus of examples 1-13 and/or some other examples herein, wherein the sensors are to track and collect data on the user's head movement relative to the multimedia stream, and the one or more control instructions are generated based at least in part on the collected data on the user's head movement.

Example 18 may include the apparatus of example 17 and/or some other examples herein, wherein one of the one or more generated control instructions is to attempt to keep the camera or the robot steady when the data on the user's head movement indicates the user head is stationary with respect to the multimedia stream, one of the one or more generated control instructions is to move the camera or the robot rightward when the data on the user's head movement indicates the user's head moves rightward related to the multimedia stream, one of the one or more generated control instructions is to move the camera or the robot leftward when the data on the user's head movement indicates the user's head moves to leftward related to the multimedia stream, and one of the one or more generated control instructions is to flip the camera or the robot 180 degree when the data on the user's head movement indicates the user's head tilts at forty-five degrees.

Example 19 may include an apparatus comprising: a processor with one or more processor cores; a receiver to receive data, wherein the received data is collected data on a user's physical response to a multimedia stream captured and provided in real time by a camera disposed on a robot, or intermediate or derived data that describe the user's physical response to the multimedia stream; a control module coupled to the receiver and the processor to generate based on the received data one or more control instructions to control the camera or the robot; and a transmitter coupled to the control module to send the generated one or more control instructions to the robot.

Example 20 may include the apparatus of example 19 and/or some other examples herein, wherein the apparatus comprises a smartphone or a portable drone control having the processor, the receiver, the control module, and the transmitter.

Example 21 may include the apparatus of example 19 and/or some other examples herein, wherein the robot is a drone.

Example 22 may include the apparatus of example 19 and/or some other examples herein, wherein the received data are received with an indication of a source of the user's physical response.

Example 23 may include the apparatus of example 19 and/or some other examples herein, wherein the received data are received in reserved spaces within communication packets of a wireless communication protocol.

Example 24 may include the apparatus of example 19 and/or some other examples herein, wherein the received data is received from a wearable device comprising a display device to display the multimedia stream to the user and sensors to collect the collected data on the user's physical response to the multimedia stream.

Example 25 may include the apparatus of examples 19-24 and/or some other examples herein, wherein the the user's physical response is related to the user's eye movement relative to the multimedia stream, and the one or more control instructions are generated based at least in part on the user's eye movement.

Example 26 may include the apparatus of example 25 and/or some other examples herein, wherein one of the one or more generated control instructions is to attempt to keep the camera or the robot steady when the data on the user's eye movement indicates the user's eyes are staring at an object of the multimedia stream, one of the one or more generated control instructions is to move the camera or the robot rightward when the data on the user's eye movement indicates the user eyes move rightward related to the multimedia stream, and one of the one or more generated control instructions is to move the camera or the robot leftward when the data on the user's eye movement indicates the user eyes move to leftward related to the multimedia stream.

Example 27 may include the apparatus of example 25 and/or some other examples herein, wherein one of the one or more generated control instructions is to instruct the camera to zoom out when the data on the user's eye movement indicates the user's eyes are panning a displayed scene, one of the one or more generated control instructions is to instruct the camera to zoom in when the data on the user's eye movement indicates the user's eyes are focusing on a portion of a displayed scene, one of the one or more generated control instructions is to instruct the camera to pause midair when the data on the user's eye movement indicates the user's eyes blink twice quickly, and one of the one or more generated control instructions is to instruct the camera to take a snapshot and keep the snapshot in a storage local to the camera or the robot when the data on the user's eye movement indicates the user's eyes blink three times quickly.

Example 28 may include the apparatus of examples 19-24 and/or some other examples herein, wherein the user's physical response is related to the user's head movement relative to the multimedia stream, and the one or more control instructions are generated based at least in part on the collected data on the user's head movement.

Example 29 may include the apparatus of example 28 and/or some other examples herein, wherein one of the one or more generated control instructions is to attempt to keep the camera or the robot steady when the data on the user's head movement indicates the user head is stationary with respect to the multimedia stream, one of the one or more generated control instructions is to move the camera or the robot rightward when the data on the user's head movement indicates the user's head moves rightward related to the multimedia stream, one of the one or more generated control instructions is to move the camera or the robot leftward when the data on the user's head movement indicates the user's head moves to leftward related to the multimedia stream, and one of the one or more generated control instructions is to flip the camera or the robot 180 degree when the data on the user's head movement indicates the user's head tilts at forty-five degrees.

Example 30 may include an apparatus comprising: means for capturing and generating a multimedia stream in real time; means for sending the multimedia stream, as it is generated, to a wearable device; and means for receiving collected data on a user's physical response to the multimedia stream, or intermediate or derived data that describe the user's physical response to the multimedia stream, or one or more control instructions to control the capturing and generating means, or the apparatus; wherein the one or more control instructions are generated based on the collected data on the user's physical response to the multimedia stream.

Example 31 may include the apparatus of example 30 and/or some other examples herein, wherein means for receiving comprises means for receiving from either the wearable device worn by the user to receive the multimedia stream, or a separate mobile device proximally disposed from the wearable device.

Example 32 may include the apparatus of example 30 and/or some other examples herein, wherein the means for receiving is for receiving the collected data on a user's physical response to the multimedia stream, or the intermediate or derived data that describe the user's physical response to the multimedia stream, and wherein the apparatus further comprises: means for generating the one or more control instructions to control the capturing and generating means or the apparatus, based on the collected data, or the intermediate or derived data.

Example 33 may include the apparatus of example 30 and/or some other examples herein, wherein the received one or more control instructions, the collected data, or the intermediate or derived data are received with an indication of a source of the user's physical response.

Example 34 may include the apparatus of example 30 and/or some other examples herein, wherein the received one or more control instructions, the collected data, or the intermediate or derived data are received in reserved spaces within communication packets of a wireless communication protocol.

Example 35 may include the apparatus of example 30 and/or some other examples herein, wherein the received one or more control instructions, the collected data, or the intermediate or derived data are received from the wearable device; wherein the wearable device comprises a display device to display the multimedia stream to the user, and sensors to collect the collected data on the user's physical response to the multimedia stream.

Example 36 may include the apparatus of examples 30-35 and/or some other examples herein, wherein the user's physical response is related to user's eye movement relative to the multimedia stream, and the one or more control instructions are generated based at least in part on the collected data on the user's eye movement.

Example 37 may include the apparatus of example 36 and/or some other examples herein, wherein one of the one or more generated control instructions is to attempt to keep the means for capturing and generating the multimedia stream or the apparatus steady when the data on the user's eye movement indicates the user's eyes are staring at an object of the multimedia stream, one of the one or more generated control instructions is to move the means for capturing and generating the multimedia stream or the apparatus rightward when the data on the user's eye movement indicates the user eyes move rightward related to the multimedia stream, and one of the one or more generated control instructions is to move the means for capturing and generating the multimedia stream or the apparatus leftward when the data on the user's eye movement indicates the user eyes move to leftward related to the multimedia stream.

Example 38 may include the apparatus of example 36 and/or some other examples herein, wherein one of the one or more generated control instructions is to instruct the means for capturing and generating the multimedia stream to zoom out when the data on the user's eye movement indicates the user's eyes are panning a displayed scene, one of the one or more generated control instructions is to instruct the means for capturing and generating the multimedia stream to zoom in when the data on the user's eye movement indicates the user's eyes are focusing on a portion of a displayed scene, one of the one or more generated control instructions is to instruct the means for capturing and generating the multimedia stream to pause midair when the data on the user's eye movement indicates the user's eyes blink twice quickly, and one of the one or more generated control instructions is to instruct the means for capturing and generating the multimedia stream to take a snapshot and keep the snapshot in a storage local to the means for capturing and generating the multimedia stream when the data on the user's eye movement indicates the user's eyes blink three times quickly.

Example 39 may include the apparatus of examples 30-35 and/or some other examples herein, wherein the user's physical response is related to user's head movement relative to the multimedia stream, and the one or more control instructions are generated based at least in part on the collected data on the user's head movement.

Example 40 may include the apparatus of example 39 and/or some other examples herein, wherein one of the one or more generated control instructions is to attempt to keep the means for capturing and generating the multimedia stream or the apparatus steady when the data on the user's head movement indicates the user head is stationary with respect to the multimedia stream, one of the one or more generated control instructions is to move the means for capturing and generating the multimedia stream or the apparatus rightward when the data on the user's head movement indicates the user's head moves rightward related to the multimedia stream, one of the one or more generated control instructions is to move the means for capturing and generating the multimedia stream or the apparatus leftward when the data on the user's head movement indicates the user's head moves to leftward related to the multimedia stream, and one of the one or more generated control instructions is to flip the means for capturing and generating the multimedia stream or the apparatus 180 degree when the data on the user's head movement indicates the user's head tilts at forty-five degrees.

Example 41 may include a method for consuming a multimedia stream, comprising: collecting data on a user's physical response to a multimedia stream captured and provided in real time by a camera disposed on a robot; and causing one or more control instructions to control the camera or the robot to be generated based on the collected data, and provided to the camera or the robot.

Example 42 may include the method of example 41 and/or some other examples herein, wherein causing comprises: generating the one or more control instructions to control the camera or the robot based on the collected data; and transmitting the one or more control instructions to the robot or the camera to control the robot or the camera.

Example 43 may include the method of example 41 and/or some other examples herein, wherein causing comprises transmitting the collected data to a proximally disposed mobile device or the robot; wherein by the mobile device or the robot is to generate the one or more control instructions to control the camera or the robot, based on the collected data.

Example 44 may include the method of example 41 and/or some other examples herein, wherein causing comprises: processing the collected data to generate intermediate or derived data that describe the user's physical response; transmitting the collected data to a proximally disposed mobile device or the robot; wherein by the mobile device or the robot is to generate the one or more control instructions to control the camera or the robot, based on the collected data.

Example 45 may include the method of example 41 and/or some other examples herein, wherein causing comprises: processing the collected data to generate intermediate or derived data that describe the user's physical response; and transmitting the intermediate or derived data to a proximally disposed mobile device or the robot; wherein the mobile device or the robot is to process the intermediate or derived data to generate the one or more control instructions to control the camera or the robot.

Example 46 may include the method of example 42 and/or some other examples herein, wherein transmitting comprises transmitting the one or more control instructions with an indication of a source of the user's physical response.

Example 47 may include the method of example 42 and/or some other examples herein, wherein transmitting comprises transmitting the one or more control instructions in reserved spaces within communication packets of a wireless communication protocol.

Example 48 may include the method of examples 41-47 and/or some other examples herein, wherein collecting comprises employing sensors to collect data on the user's physical response to the multimedia stream.

Example 49 may include the method of example 48 and/or some other examples herein, wherein employing sensors comprises employing sensors are to track and collect data on the user's eye movement relative to the multimedia stream, and the one or more control instructions are generated based at least in part on the collected data on the user's eye movement.

Example 50 may include the method of example 49 and/or some other examples herein, wherein one of the one or more generated control instructions is to attempt to keep the camera or the robot steady when the data on the user's eye movement indicates the user's eyes are staring at an object of the multimedia stream, one of the one or more generated control instructions is to move the camera or the robot rightward when the data on the user's eye movement indicates the user eyes move rightward related to the multimedia stream, and one of the one or more generated control instructions is to move the camera or the robot leftward when the data on the user's eye movement indicates the user eyes move to leftward related to the multimedia stream.

Example 51 may include the method of example 49 and/or some other examples herein, wherein one of the one or more generated control instructions is to instruct the camera to zoom out when the data on the user's eye movement indicates the user's eyes are panning a displayed scene, one of the one or more generated control instructions is to instruct the camera to zoom in when the data on the user's eye movement indicates the user's eyes are focusing on a portion of a displayed scene, one of the one or more generated control instructions is to instruct the camera to pause midair when the data on the user's eye movement indicates the user's eyes blink twice quickly, and one of the one or more generated control instructions is to instruct the camera to take a snapshot and keep the snapshot in a storage local to the camera or the robot when the data on the user's eye movement indicates the user's eyes blink three times quickly.

Example 52 may include the method of example 48 and/or some other examples herein, wherein employing sensors comprises employing sensors to track and collect data on the user's head movement relative to the multimedia stream, and the one or more control instructions are generated based at least in part on the collected data on the user's head movement.

Example 53 may include the method of example 52 and/or some other examples herein, wherein one of the one or more generated control instructions is to attempt to keep the camera or the robot steady when the data on the user's head movement indicates the user head is stationary with respect to the multimedia stream, one of the one or more generated control instructions is to move the camera or the robot rightward when the data on the user's head movement indicates the user's head moves rightward related to the multimedia stream, one of the one or more generated control instructions is to move the camera or the robot leftward when the data on the user's head movement indicates the user's head moves to leftward related to the multimedia stream, and one of the one or more generated control instructions is to flip the camera or the robot 180 degree when the data on the user's head movement indicates the user's head tilts at forty-five degrees.

Example 54 may include one or more non-transitory computer-readable media comprising instructions that cause a computing device, in response to execution of the instructions by the computing device, to: collect data, or receive collected data or intermediate or derived data of the collected data, wherein the collected data are related to a user's physical response to a multimedia stream captured and provided in real time by a camera disposed on a robot, and the intermediate or derived data describe the user's physical response; and generate the intermediate or derived data, or one or more control instructions to control the camera or the robot in continuously capturing and providing of the multimedia stream.

Example 55 may include the one or more non-transitory computer-readable media of example 54 and/or some other examples herein, wherein the computing device is a wearable device comprising a display device to display the multimedia stream to the user and sensors to collect data on the user's physical response to the multimedia stream.

Example 56 may include the one or more non-transitory computer-readable media of example 54 and/or some other examples herein, wherein the computing device is a mobile device to receive the collected data or the intermediate or derived data from a wearable device and to generate the intermediate or derived data or the one more control instructions.

Example 57 may include the one or more non-transitory computer-readable media of example 54 and/or some other examples herein, wherein the computing device is the robot, wherein collect data or receive collected data or intermediate or derived data of the collected data comprises receive the collected data or the intermediate data from a wearable device or a mobile device proximally disposed from the wearable device.

Example 58 may include the one or more non-transitory computer-readable media of examples 54-57 and/or some other examples herein, wherein the user's physical response is related to user's eye movement relative to the multimedia stream, and the one or more control instructions are generated based at least in part on the collected data on the user's eye movement.

Example 59 may include the one or more non-transitory computer-readable media of example 58 and/or some other examples herein, wherein one of the one or more generated control instructions is to attempt to keep the camera or the robot steady when the data on the user's eye movement indicates the user's eyes are staring at an object of the multimedia stream, one of the one or more generated control instructions is to move the camera or the robot rightward when the data on the user's eye movement indicates the user eyes move rightward related to the multimedia stream, and one of the one or more generated control instructions is to move the camera or the robot leftward when the data on the user's eye movement indicates the user eyes move to leftward related to the multimedia stream.

Example 60 may include the one or more non-transitory computer-readable media of example 58 and/or some other examples herein, wherein one of the one or more generated control instructions is to instruct the camera to zoom out when the data on the user's eye movement indicates the user's eyes are panning a displayed scene, one of the one or more generated control instructions is to instruct the camera to zoom in when the data on the user's eye movement indicates the user's eyes are focusing on a portion of a displayed scene, one of the one or more generated control instructions is to instruct the camera to pause midair when the data on the user's eye movement indicates the user's eyes blink twice quickly, and one of the one or more generated control instructions is to instruct the camera to take a snapshot and keep the snapshot in a storage local to the camera or the robot when the data on the user's eye movement indicates the user's eyes blink three times quickly.

Example 61 may include the one or more non-transitory computer-readable media of example 54 and/or some other examples herein, wherein the user's physical response is related to user's head movement relative to the multimedia stream, and the one or more control instructions are generated based at least in part on the collected data on the user's head movement.

Example 62 may include the one or more non-transitory computer-readable media of examples 54-57 and/or some other examples herein, wherein one of the one or more generated control instructions is to attempt to keep the camera or the robot steady when the data on the user's head movement indicates the user head is stationary with respect to the multimedia stream, one of the one or more generated control instructions is to move the camera or the robot rightward when the data on the user's head movement indicates the user's head moves rightward related to the multimedia stream, one of the one or more generated control instructions is to move the camera or the robot leftward when the data on the user's head movement indicates the user's head moves to leftward related to the multimedia stream, and one of the one or more generated control instructions is to flip the camera or the robot 180 degree when the data on the user's head movement indicates the user's head tilts at forty-five degrees.

Example 63 may include an apparatus for a multimedia stream comprising: a camera disposed on a robot to capture and generate a multimedia stream in real time; a transmitter to send the multimedia stream, as it is generated, to a wearable device; and a receiver to receive collected data on a user's physical response to the multimedia stream, or intermediate or derived data that describe the user's physical response to the multimedia stream, or one or more control instructions to control the camera, or the robot; wherein the one or more control instructions are generated based on the collected data on the user's physical response to the multimedia stream.

Example 64 may include the apparatus of example 63 and/or some other examples herein, wherein the receiver receives from either the wearable device worn by the user to receive the multimedia stream, or a separate mobile device proximally disposed from the wearable device.

Example 65 may include the apparatus of example 63 and/or some other examples herein, wherein the receiver receives the collected data on a user's physical response to the multimedia stream, or the intermediate or derived data that describe the user's physical response to the multimedia stream, and wherein the apparatus further comprises: a control module to generate the one or more control instructions to control the camera or the robot for capturing and generating the multimedia stream, based on the collected data, or the intermediate or derived data.

Example 66 may include the apparatus of example 63 and/or some other examples herein, wherein the received one or more control instructions, the collected data, or the intermediate or derived data are received with an indication of a source of the user's physical response.

Example 67 may include the apparatus of example 63 and/or some other examples herein, wherein the received one or more control instructions, the collected data, or the intermediate or derived data are received in reserved spaces within communication packets of a wireless communication protocol.

Example 68 may include the apparatus of example 63 and/or some other examples herein, wherein the received one or more control instructions, the collected data, or the intermediate or derived data are received from the wearable device; wherein the wearable device comprises a display device to display the multimedia stream to the user, and sensors to collect the collected data on the user's physical response to the multimedia stream.

Example 69 may include any one of the apparatus of examples 63-68 and/or some other examples herein, wherein the user's physical response is related to user's eye movement relative to the multimedia stream, and the one or more control instructions are generated based at least in part on the collected data on the user's eye movement.

Example 70 may include the apparatus of example 69 and/or some other examples herein, wherein one of the one or more generated control instructions is to attempt to keep the camera or the robot steady when the data on the user's eye movement indicates the user's eyes are staring at an object of the multimedia stream, one of the one or more generated control instructions is to move the camera or the robot rightward when the data on the user's eye movement indicates the user eyes move rightward related to the multimedia stream, and one of the one or more generated control instructions is to move the camera or the robot leftward when the data on the user's eye movement indicates the user eyes move to leftward related to the multimedia stream.

Example 71 may include the apparatus of example 69 and/or some other examples herein, wherein one of the one or more generated control instructions is to instruct the camera to zoom out when the data on the user's eye movement indicates the user's eyes are panning a displayed scene, one of the one or more generated control instructions is to instruct the camera to zoom in when the data on the user's eye movement indicates the user's eyes are focusing on a portion of a displayed scene, one of the one or more generated control instructions is to instruct the camera to pause midair when the data on the user's eye movement indicates the user's eyes blink twice quickly, and one of the one or more generated control instructions is to instruct the camera to take a snapshot and keep the snapshot in a storage local to the camera or the robot when the data on the user's eye movement indicates the user's eyes blink three times quickly.

Example 72 may include any one of the apparatus of examples 63-68 and/or some other examples herein, wherein the user's physical response is related to user's head movement relative to the multimedia stream, and the one or more control instructions are generated based at least in part on the collected data on the user's head movement.

Example 73 may include the apparatus of example 72 and/or some other examples herein, wherein one of the one or more generated control instructions is to attempt to keep the camera or the robot steady when the data on the user's head movement indicates the user head is stationary with respect to the multimedia stream, one of the one or more generated control instructions is to move the camera or the robot rightward when the data on the user's head movement indicates the user's head moves rightward related to the multimedia stream, one of the one or more generated control instructions is to move the camera or the robot leftward when the data on the user's head movement indicates the user's head moves to leftward related to the multimedia stream, and one of the one or more generated control instructions is to flip the camera or the robot 180 degree when the data on the user's head movement indicates the user's head tilts at forty-five degrees.

What is claimed is:

1. An apparatus for consuming a multimedia stream, comprising:
a receiver to receive a multimedia stream captured and provided in real time by a camera disposed on a robot, wherein the multimedia stream is to be displayed for a user; and
sensors to collect data on the user's physical response to the multimedia stream, wherein the collected data on the user's physical response are to be used to generate one or more control instructions to control the camera or the robot.

2. The apparatus of claim 1, further comprising a display device coupled to the receiver to display the multimedia stream for the user.

3. The apparatus of claim 1, further comprising:
a transmitter coupled to the sensors to transmit the collected data to a proximally disposed mobile device to process the collected data to generate the one or more control instructions to control the camera or the robot.

4. The apparatus of claim 3, wherein the mobile device comprises a smartphone or a portable drone controller.

5. The apparatus of claim 1, further comprising:
a transmitter coupled to the sensors to transmit the collected data to the robot to process the collected data to generate the one or more control instructions to control the camera or the robot.

6. The apparatus of claim 1, further comprising:
a processor with one or more processor cores;
a control module coupled with the sensors and the processor to process the collected data to generate intermediate or derived data that describe the user's physical response; and
a transmitter coupled to the control module to transmit the generated intermediate or derived data to either a proximally disposed mobile device or the robot to generate the one or more control instructions to control the camera or the robot.

7. The apparatus of claim 1, further comprising
a processor with one or more processor cores;
a control module coupled with the sensors and the processor to process the collected data to generate the one or more control instructions to control the camera or the robot; and
a transmitter coupled with the control module to transmit the one or more control instructions to the robot.

8. The apparatus of claim 7, wherein the sensors are to track and collect data on the user's eye movement relative to the multimedia stream, and the one or more control instructions are generated based at least in part on the collected data on the user's eye movement.

9. The apparatus of claim 8, wherein one of the one or more generated control instructions is to attempt to keep the camera or the robot steady when the data on the user's eye movement indicates the user's eyes are staring at an object of the multimedia stream, one of the one or more generated control instructions is to move the camera or the robot rightward when the data on the user's eye movement indicates the user eyes move rightward related to the multimedia stream, and one of the one or more generated control instructions is to move the camera or the robot leftward when the data on the user's eye movement indicates the user eyes move to leftward related to the multimedia stream.

10. The apparatus of claim 8, wherein one of the one or more generated control instructions is to instruct the camera to zoom out when the data on the user's eye movement indicates the user's eyes are panning a displayed scene, one of the one or more generated control instructions is to instruct the camera to zoom in when the data on the user's eye movement indicates the user's eyes are focusing on a portion of a displayed scene, one of the one or more generated control instructions is to instruct the camera to pause midair when the data on the user's eye movement indicates the user's eyes blink twice quickly, and one of the one or more generated control instructions is to instruct the camera to take a snapshot and keep the snapshot in a storage local to the camera or the robot when the data on the user's eye movement indicates the user's eyes blink three times quickly.

11. An apparatus for a multimedia stream, comprising:
a processor with one or more processor cores;
a receiver to receive data, wherein the received data is collected data on a user's physical response to a multimedia stream captured and provided in real time by a camera disposed on a robot, or intermediate or derived data that describe the user's physical response to the multimedia stream;
a control module coupled to the receiver and the processor to generate based on the received data one or more control instructions to control the camera or the robot; and
a transmitter coupled to the control module to send the generated one or more control instructions to the robot.

12. The apparatus of claim 11, wherein the apparatus comprises a smartphone or a portable drone control having the processor, the receiver, the control module, and the transmitter.

13. The apparatus of claim 11, wherein the received data are received with an indication of a source of the user's physical response.

14. The apparatus of claim 11, wherein the received data are received in reserved spaces within communication packets of a wireless communication protocol.

15. The apparatus of claim 11, wherein the received data is received from a wearable device comprising a display device to display the multimedia stream to the user and sensors to collect the collected data on the user's physical response to the multimedia stream.

16. One or more non-transitory computer-readable media comprising instructions that cause a computing device, in response to execution of the instructions by the computing device, to:
collect data, or receive collected data or intermediate or derived data of the collected data, wherein the collected data are related to a user's physical response to a multimedia stream captured and provided in real time by a camera disposed on a robot, and the intermediate or derived data describe the user's physical response; and
generate the intermediate or derived data, or one or more control instructions to control the camera or the robot in continuously capturing and providing of the multimedia stream.

17. The one or more non-transitory computer-readable media of claim 16, wherein the computing device is a wearable device comprising a display device to display the multimedia stream to the user and sensors to collect data on the user's physical response to the multimedia stream.

18. The one or more non-transitory computer-readable media of claim 16, wherein the computing device is a mobile device to receive the collected data or the intermediate or derived data from a wearable device and to generate the intermediate or derived data or the one more control instructions.

19. The one or more non-transitory computer-readable media of claim 16, wherein the computing device is the robot, wherein collect data or receive collected data or intermediate or derived data of the collected data comprises receive the collected data or the intermediate data from a wearable device or a mobile device proximally disposed from the wearable device.

20. An apparatus for a multimedia stream, comprising:
a camera disposed on a robot to capture and generate a multimedia stream in real time;
a transmitter to send the multimedia stream, as it is generated, to a wearable device; and
a receiver to receive collected data on a user's physical response to the multimedia stream, or intermediate or derived data that describe the user's physical response to the multimedia stream, or one or more control instructions to control the camera, or the robot; wherein the one or more control instructions are generated based on the collected data on the user's physical response to the multimedia stream.

21. The apparatus of claim 20, wherein the receiver receives from either the wearable device worn by the user to receive the multimedia stream, or a separate mobile device proximally disposed from the wearable device.

22. The apparatus of claim 20, wherein the receiver receives the collected data on a user's physical response to the multimedia stream, or the intermediate or derived data that describe the user's physical response to the multimedia stream, and wherein the apparatus further comprises:
a control module to generate the one or more control instructions to control the camera for capturing and generating the multimedia stream, based on the collected data, or the intermediate or derived data.

23. The apparatus of claim 20, wherein the received one or more control instructions, the collected data, or the intermediate or derived data are received with an indication of a source of the user's physical response.

24. The apparatus of claim 20, wherein the received one or more control instructions, the collected data, or the intermediate or derived data are received in reserved spaces within communication packets of a wireless communication protocol.

25. The apparatus of claim 20, wherein the received one or more control instructions, the collected data, or the intermediate or derived data are received from the wearable device; wherein the wearable device comprises a display device to display the multimedia stream to the user, and sensors to collect the collected data on the user's physical response to the multimedia stream.
